(19) United States
(12) Patent Application Publication
(10) Pub. No.: US 2017/0316040 A1
(43) Pub. Date: Nov. 2, 2017

(54) ATTRIBUTE BIT-STATE MAPPER

(71) Applicant: HEWLETT PACKARD ENTERPRISE DEVELOPMENT LP, Fort Collins, CO (US)

(72) Inventor: Joseph Miller, Boulder, CO (US)

(73) Assignee: HEWLETT PACKARD ENTERPRISE, Fort Collins, CO (US)

(21) Appl. No.: 15/142,540

(22) Filed: Apr. 29, 2016

(51) Int. Cl. G06F 17/30; G06Q 10/06; G06N 5/04; G06Q 30/02

(52) U.S. Cl. CPC G06F 17/30324; G06Q 30/0201; G06F 17/30424; G06N 5/045; G06Q 10/0637

(57) ABSTRACT

An attribute bit-state mapper to receive state decisions, each state decision including a current one-bit state and identity information, the current one-bit state corresponding to a one-bit answer from a decision network indicative of a state of an attribute of an entity of a population of entities identified by the identity information. The attribute bit-state mapper to assign each population of entities to a population data set, and to assign to each entity of a population data set coordinates with the corresponding population data set. The attribute bit-state mapper further to maintain for each population data set a current data set including, at the assigned coordinates, the current bit-state for each entity, and a past data set comprising a copy of the current data set from an earlier point in time.

### BACKGROUND

Systems to track and analyze an attribute of a population of entities, particularly large populations of entities (e.g., a population of millions of entities) may consume large amounts of system resources (e.g., memory and computing resources).

### BRIEF DESCRIPTION OF THE DRAWINGS

FIG. 1 is a block and schematic diagram illustrating an attribute bit-state mapper, according to one example of the present disclosure.

FIG. 2 is a block and schematic diagram illustrating an attribute bit-state mapper, according to one example of the present disclosure.

FIG. 3 is a block diagram generally illustrating a population data set according to one example.

FIG. 4 is a block diagram generally illustrating a state comparison between current and past data sets according to one example.

FIG. 5 is a block and schematic diagram illustrating a computing system for implementing an attribute bit-state mapper according to one example.

FIG. 6 is a flow diagram illustrating a method 250 of mapping attribute bit-states according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Monitoring an attribute of a population of entities can provide information helpful in decision-making with regard to such populations of entities. For example, where the entity is a person and the population of entities is all people living within a given state who are of legal voting age, it may be helpful to a political party (i.e., the enterprise) when determining where to purchase television advertising, to track over time whether or not each person in the given state is an independent voter (i.e., the attribute). However, tracking and analyzing the state of the attribute of each entity over time for a large population of entities (e.g. a population of millions of entities) may consume great amounts of system resources (e.g., memory and computing resources).

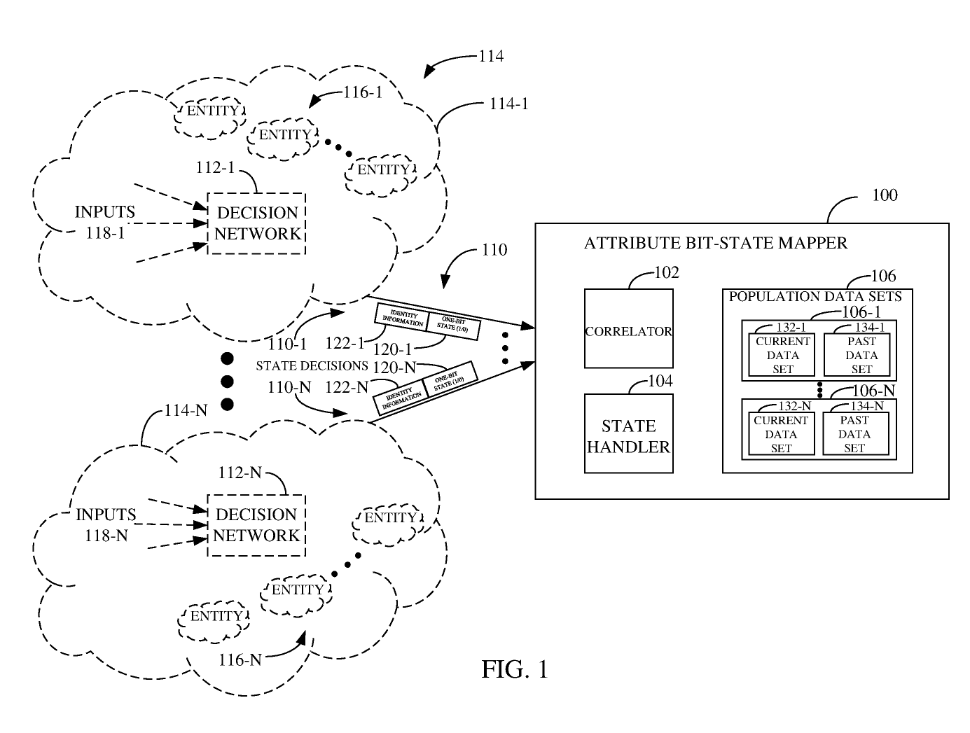

FIG. 1 is a block and schematic diagram generally illustrating and describing an attribute bit-state mapper, in accordance with one example of the present disclosure, which enables trend information to be generated for an attribute of populations of entities without a large memory and computing resource footprint by maintaining current and past data sets of bit-states representative of current and past states of the attribute of each entity of the population of entities. According to one example, as illustrated, attribute bit-state mapper 100 includes a correlator 102, a state handler 104, and population data sets 106.

According to one example, attribute bit-state mapper 100 receives state decisions 110 from decision networks 112 associated with populations of entities 114, such as state decisions 110-1 to 110-N from decision networks 112-1 to 112-N corresponding to populations of entities 114-1 to 114-N, for instance. Entities 116 of the populations of the populations of entities 114 may be anything (e.g., a person, an article, an operation, a function, to name a few) having an attribute with a state that may change over time and, when tracked to monitor changes over time, may provide an enterprise (e.g., a business, an organization, a government agency, etc.) with information valuable for making decisions with respect to the population of entities, such as an allocation of resources, for instance.

For example, entities 116-1 of population 114-1 may be people, and population 114-1 may be all people in the city of Chicago, and the attribute being tracked is whether each person 116-1 owns an automobile. Decision network 112-1 receives any number of inputs 118-1 that may be representative of whether an individual person 116-1 owns an automobile, such as credit card purchase information (e.g., purchases at gas stations), whether the person has a driver's license, the person's age, whether the person has traffic violations, whether the person owns automobile insurance, for example. Decision network 112-1 correlates these various inputs 118-1 to individual persons 116-1 of population 114-1 and, based on the various inputs 118-1 corresponding to each individual person, provides a one-bit answer representative of a current state (“yes” or “no”) of the attribute (in this case, whether the individual person owns an automobile).

In this fashion, decision network 112-1 makes on-going state decisions for individual persons 116-1 of population 114-1 as inputs 118-1 are received and provides such state decisions 110-1 to attribute bit-state mapper 100. According to one example, each state decision 110-1 includes a one-bit state 120-1 (i.e., a “1” or a “0”) corresponding to a one-bit answer from decision network 112-1 indicative of the state of the monitored attribute (in this case, “whether a person owns an automobile”), and identifying information 122-1 correlating the one-bit state 120-1 to the population of entities 112-1 and to a particular person 116-1 (where a state of “1” might indicate that the person owns an automobile and a state of “0” might indicate that the person does not own and automobile).

In another example, entities 116-N of population 114-N may be delivery trucks, and population 114-N may be all delivery trucks of a fleet of delivery trucks of a trucking enterprise, and the attribute being tracked is whether each truck is currently in the process of making a delivery. Inputs 118-N to decision network 112-N may include a GPS position of the truck and inputs from a dispatch department of the trucking enterprise, for example. Decision network 112-N correlates the inputs 118-N to individual delivery trucks 116-N of the fleet of delivery trucks 114-N and provides on-going state decisions 110-N as to the monitored attribute of individual trucks 116-N (in this case, whether a truck is in the process of making a delivery, “yes” or “no”) to attribute bit-state mapper 100. As above, each state decision 110-N includes a one-bit state 120-N corresponding to a one-bit answer from decision network 112-N indicative of the state (“1” or “0”) of the monitored attribute, and identity information 122-N correlating the one-bit state 120-N to the population of entities 112-N and to a particular entity 116-1 within population 120-N (in this case, a particular delivery truck).

In one example, decision networks 112 may be neural networks configured to provide a bit-answer based on the various inputs 118. Also, in addition to providing a one-bit state for attributes having only a “yes” or “no” answer, decision networks 112, including neural networks, can be configured to provide a one-bit state representative of one of a pair predefined answers to a question. Regardless of the type of decision network 112 employed and the attribute whose state is being answered, state decisions 110 provided by decision networks 112 include a current one-bit state 120 and identity information 122, the current one-bit state corresponding to a one-bit answer from the decision network 112 which is indicative of a state of an attribute of an entity 118 of a population of entities 114.

Correlator 102 receives state decisions 110 and, based on identity information 122, assigns each population of entities 114, such as populations of entities 114-1 to 114-N, to a corresponding one of a plurality of population data sets 106, such as to population data sets 106-1 to 106-N, respectively. In one example, based on identity information 122, correlator 102 assigns to the entity 118 associated with the current one-bit state 120 persistent coordinates for the corresponding population data set 106, where such coordinates remain unchanged for the entity 118 for as long as the attribute of the population of entities is monitored (i.e., for as long as population data set exists). It is noted that identity information 122 may not identify to attribute bit-state mapper 100 the nature of the corresponding population 116 or the individual entity, but may simply provide a label or identifier that is associated with the population of entities and an identifier associated with the entity itself that does not change over time. As such, attribute bit-state mapper 100 may not know what the one-bit state 120 represents nor the nature of the entity 116 or population or the population of entities 114, but knows simply that the given one-bit state 120 has a state of “1” or “0” and is always associated with corresponding identity information 122. In this way, the nature of the state and population remains unknown to attribute bit-state mapper 100.

In one example, state handler 104 maintains a population data set 106 for each population of entities 114, such as population data sets 106-1 to 106-N respectively corresponding to populations of entities 114-1 to 114-N. In one example, each population data set 106 includes a current data set 132 and a past data set 134. As state decisions 110 are received by attribute bit-state mapper 100, state handler 104 maintains a current data set 132 for each population of entities 114 by storing the current one-bit state 120 for each entity 118 (i.e., the most recently received) at the assigned coordinates provided by correlator 102. In one example, state handler 104 maintains at least one past data set 134 for each population of entities 114 by storing a copy of current data set 132 from an earlier point in time, such that the past data set 134 stores the earlier one-bit states at the same assigned set of coordinates. In one example, state handler 104 maintains a plurality of past data sets 134, each from a different point in time.

Currently, systems to track and analyze an attribute of a population of entities, particularly a large population of entities, may consume large amounts of system memory and processing resources. In contrast, by using only a single bit to represent a status of an entity of a population of entities, an attribute bit-state mapper in accordance with the present disclosure, such as attribute bit-state mapper 100, greatly reduces system data storage requirements. For example, tracking an attribute state of each person in the world (approximately 7.4 billion people) would require less than 2-gigabytes of memory, less than the storage capacity of a typical smartphone. Additionally, by using structured data sets, where the bit-state for each attribute remains at a same (i.e., persistent) coordinate location for as long as the attribute is tracked, an attribute bit-state mapper according to the present disclosure enables attribute data of a large population of entities to be analyzed to identify trends in real-time without consuming large amounts of computing resources. For example, as described in greater detail below, an attribute bit state mapper, in accordance with the present disclosure, may compare past and current data sets to provide trend information for an attribute of the entire world population in less than one second using the graphics processing capabilities of a typical smartphone. Such real-time trend analysis, as well as such minimal storage and computing requirements, are not achieved by current analysis systems.

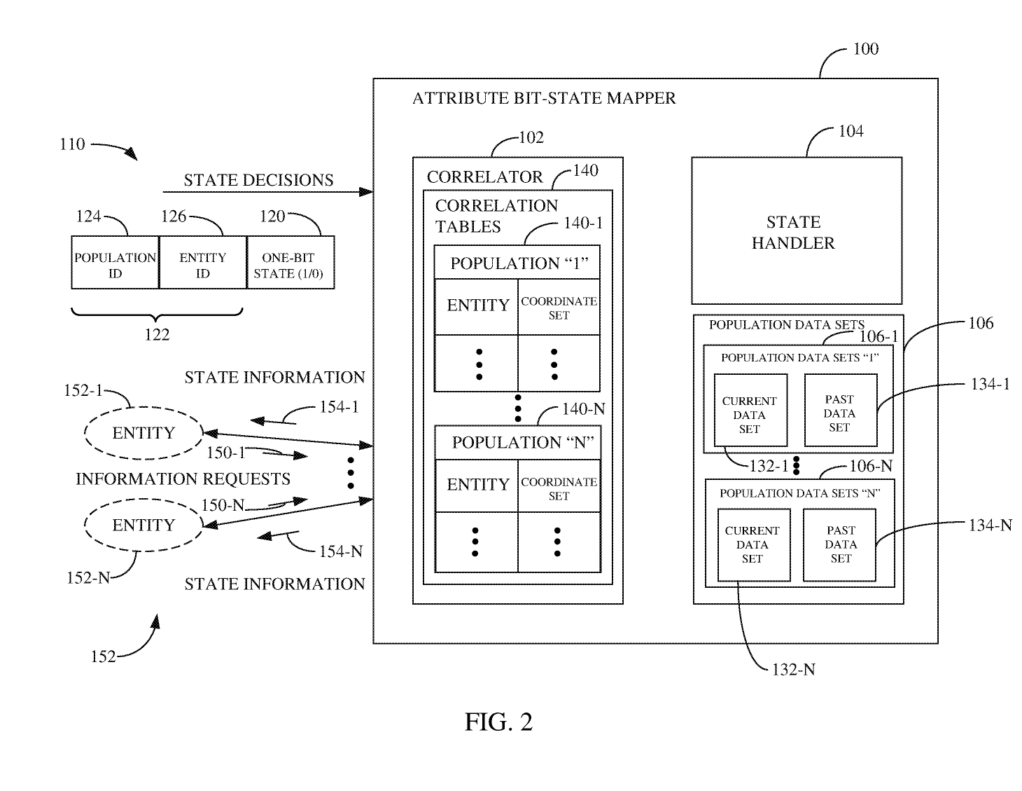

FIG. 2 is a block and schematic diagram illustrating attribute bit-state mapper 100, according to one example. According to the illustrated example, correlator 102 utilizes a plurality of correlation tables 140 for assigning coordinates to the one-bit state 120 of an entity 118 of a population of entities 114 received via state decisions 110, such as correlation tables 140-1 to 140-N respectively corresponding to populations of entities 114-1 to 114-N. In one example, each state decision 110 includes one-bit state 120 and identity information 122, with identity information 122 including a population identifier 124 and an entity identifier 126. According to one example, upon receiving a state decision 110, correlator 102 checks population identifier 124 against existing correlation tables 140 to determine whether a correlation table 140 already exists for the population identifier 124. If no correlation table exists, correlator 102 creates a correlation table 140 for the population identifier 124, creates an entity entry 142 in the newly created correlation table for the entity identifier 126, and assigns a set of coordinates 144 for the entity entry 142 corresponding to the entity identifier 126.

If a correlation table 140 already exists, correlator 102 checks the entity identifier 126 against existing entity entries 142 in the existing correlation table 140. If no entity entry 142 exists in correlation table 140 for entity identifier 126, correlator 102 creates an entity entry 142 in the existing correlation table 140 and assigns a set of coordinates 144 to the entity identifier 126. If an entity entry 142 with an assigned set of coordinates 144 already exists in the correlation table 140 for the entity identifier 126, correlator 102 assigns the existing set of coordinates 144 to the entity 116 corresponding to entity identifier 126.

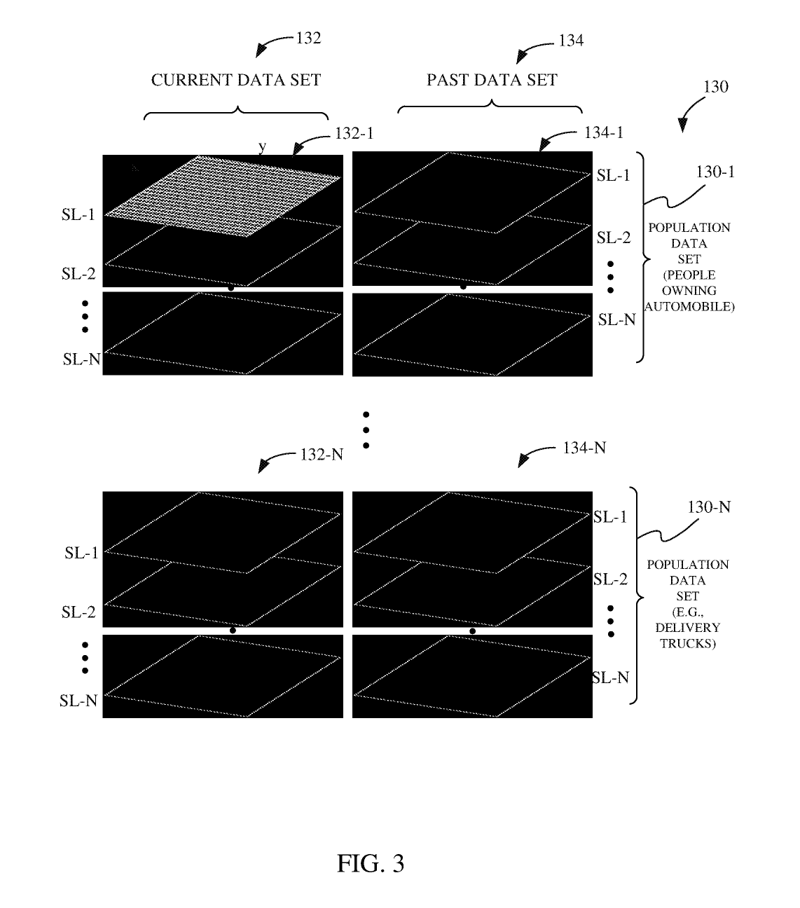

In one example, using the set of coordinates 144 assigned by correlator 102 to one-bit state 120 of each received state decision 110, state handler 104 updates the current one-bit state in the current data set 132 corresponding to the population of entities 114 identified by identity information 122. According to one example, as illustrated by FIG. 3, for each population data set 140, state handler 104 maintains current data set 132 and past data set 134 in a three-dimensional format, where each data set includes a number of slices SL-1 to SL-N, with each slice having an x-y array of bits. According to such example, a set of coordinates assigned to each one-bit state 120 of each state decision 110 may include a set of four coordinates represented as (PS, SL, x, y), where “PS” indicates the population data set 106 to which the current data set 132 to be updated belongs, “SL” indicates the slice within the current data set 132, and x and y indicate the coordinates of the bit location within the bit-array of the slice SL.

According to one example, for each of the population data sets 106 (e.g., population data sets 106-1 to 106-N), state handler 104 periodically performs one or more comparison operations between current data set 132 and past data set 134 to determine changes in the one-bit states for each entity, with such comparisons being indicative of changes (e.g., trends) in the tracked attribute of the corresponding population of entities 114. In one example, with reference to FIG. 2, such comparison operations are made in response to receiving information requests from entities associated with the populations of entities 114, such as information requests 150-1 to 150-N from entities 152-1 to 152-N associated with populations of entities 114-1 to 114-N of FIG. 1.

In one example, such comparison operations are performed for each of the population data sets 106 at selected intervals, where the selected interval can be different for each of the population data sets 106. For example, using the examples described above by FIG. 1, a comparison interval for a population data set associated with population of entities 114-N, which is associated with the attribute of whether a delivery truck is making a delivery, may be shorter than a comparison interval for a population data set associated with population of entities 114-1, which is associated with the attribute of whether a person owns a car. In one example, regardless of the comparison interval, state handler 104 provides requested state information (e.g., state information including comparison information from comparison operations) to the requesting entity, such as state information 154-1 to 154-N to entities 152-1 to 152-N. In one example, after performing a comparison between current and past data sets 132 and 134 of a given population data set 106, state handler 104 saves the bit states of the current data set 132 as the bit states of the past data set 134 and, subsequently, continues to update the bit states of the current data set 132 as current bit states are received via state decisions 110.

State handler 104 may perform any number of different types of comparison operations between current and past data sets 132 and 134, with each type of comparison operation providing different state information with respect to bit-state changes between current and past data sets 132 and 134. For instance, such comparison operations may include any number of various bitwise operations, such as AND, OR, XOR, and NOR operations, for example.

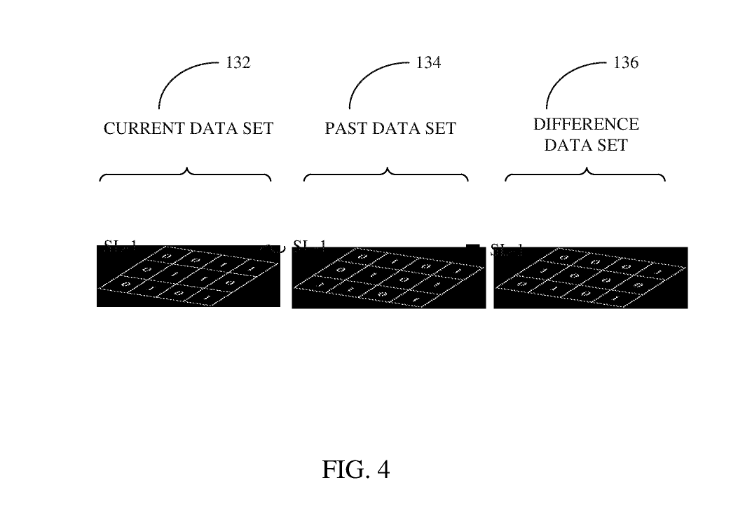

FIG. 4 illustrates generally a simplified example of a comparison operation between portions of current and past data sets 132 and 134 of FIG. 3, in this case, slice SL-1 of each data set, with example bit-states (1's and 0's) being illustrate at each coordinate location. In FIG. 4, the example comparison operation represents a bitwise AND operation between the current and past data sets, where such AND operation provides a comparison or difference data set 136, with bit states of “1’ in difference data set 136 representing entities 116 of the corresponding population of entities 114 which had a bit state of “1” in both the past and current data sets 132 and 134 (i.e., those entities having a bit state of “1” which did not change). In the illustrated example of FIG. 4, the four bits with a state of “1” indicate the four bits of the past data set 134 which still have a state of “1” in the current data set 132. Such a comparison is repeated for each slice SL of current and past data sets 132 and 134 in order to perform a comparison between the entire data sets.

In one example, in addition to maintaining current and past sets 132 and 134, state handler 104 may maintain at least one difference data set, such as comparison data set 136 resulting from a most recent performance of a bitwise AND operation as illustrated above. As described below, such a difference data set can be employed by state handler 104 to determine changes in bit-states between current and past data sets 134 and 136.

In addition to bitwise AND operations, state handler 104 may perform any number of other bitwise operations between current and past data sets 132 and 134. For example, a NOR operation may be performed between current and past data sets 132 and 134, with such NOR operation providing a difference data set indicating which bits with a state of “0” in past data set 134 still have a bit state of “0” in current data set 132. In another example, an XOR operation may be performed between current data set 132 and the difference data set 136 resulting from an AND operation of current and past data sets 132 and 134, with such XOR operation providing a difference data set indicating which bits with a state of “0” in past data set 134 have changed so as to have a state of “1” in current data set 132. In another example, an XOR operation may be performed between past data set 134 and the difference data set 136 resulting from the AND operation of current and past data sets 132 and 134, with such XOR operation providing a difference data set indicating which bits with a state of “1” in past data set 134 have a state of “0” in current data set 132.

Any suitable comparison operation may be performed, but regardless of the type of comparison operation, state handler 104 provides the resulting state information 150 to the corresponding requesting entity 152. State information 150 may include information such as the total number of bit states remaining unchanged with a state of “1”, the total number of bit states remaining unchanged with a state of “0”, the total number of bit states changing from a state of “0” to a state of “1”, and a total number of bit states changing from a state of “1” to a state of “0”.

While attribute bit state mapper 100 itself has no knowledge of what the bit-states represent, the requesting entity 152 may use state information 150 to determine trends in the monitored attribute of the corresponding population of entities. For instance, in terms of the example of the population of entities 114-1 described by FIG. 1, where a state of “1” indicates that a person owns an automobile, the number of bit states remaining unchanged with a state of “1” indicates the number of people of the monitored population who previously owned an automobile and who still currently own an automobile. Similarly, the number of bits remaining unchanged with a state of “0” indicates the number of people who previously did not own an automobile and who still do not own and automobile. Further, the number of bits changing from a state of “0” to a state of “1” indicate the number of people who previously did not own and automobile but who now currently own an automobile, while the number of bits changing from a state of “1” to a state of “0” indicate the number of people who previously owned an automobile but who currently no longer own an automobile.

In other instances, in addition to providing state information generated by performing comparison operations, state handler 104 may provide state information including numbers of bit-states at each state (i.e., “1” and “0”) for current data set 134. For example, it may be valuable for the requesting entity to determine a point in time (e.g. a point in time each day of a week) when a maximum number of bit states are set to a value of “1” or when a minimum number of bits states are set to a value of “0”.

Each of the current and past data sets 132 and 134 may be arranged to contain varying numbers of bits, depending on the number of entities 116 in the population of entities 114 being monitored, with the current and past data sets 132 and 134 of a same population data set 106 having a same number of bits. For example, with reference to FIG. 3, in one example, current and past data sets 132 and 134 for a given population data set 106 may be arranged with 128 slices, with each slice having an x-y array of 512×512 bits, which enables an attribute of a population of 33,554,432 entities to be tracked. Similarly, a data set having 512 slices, with each slice having an x-y array of 1,024×1,024 bits enables an attribute of a population of 536,870,912 entities to be tracked. If the entities were people, such data set would enable an attribute to be tracked for the entire population of the United States. A data set having 2,048 slices, with each slice having an x-y array of 2,048×2,048 bits enables a population of 8,589,934,592 entities to be tracked, more than the Earth's present population.

Although described above in terms of comparing an entire current data set 132 to an entire past data set 134, in other examples, comparisons may be made between subsets of the data sets, where such subsets may correspond to a particular sub-population of entities 116 of the population of entities 114. For example, if the population of entities 114 is the entire population of the United States, a comparison may be performed on a subset of the past and current data sets 132 and 134 corresponding to the population of the state of Colorado, for instance. Subsets of the data sets corresponding to any number of different sub-populations can be imagined.

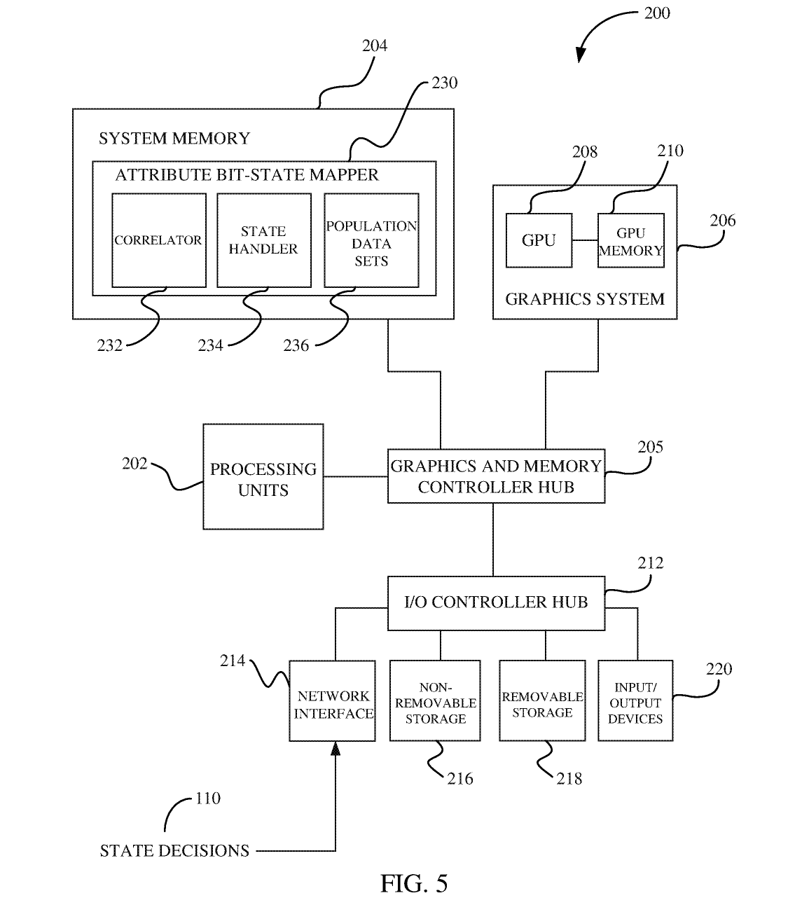

According to one example, as will be described in greater detail below (see FIG. 5), state handler 104 utilizes a graphics processing unit (GPU) for maintenance of current and past data sets 132 and 134 and for performing comparison operations there between. The parallel processing architecture of GPUs enables rapid performance of bit-wise comparison operations between current and past data sets 132 and 134 as described above. For example, using the example data set described above, current GPUs are able to compare the 2,048 slices of current data set 132 against the 2,048 slices of past data sets 134 in less than one second.

By using attribute bit-state mapper 100, in accordance with the present disclosure, attributes of large populations of entities may be tracked and changes in such attributes may be quickly determined and identified, including the development of trending information, using a small amount of system memory and computing resources. With a small system footprint (e.g. memory and computing resources), attribute bit-state mapper 100 provides attribute monitoring for any number of different attributes and enables enterprises to make resource management or other business decisions.

In one example, attribute bit-state mapper 100, including correlator 102 and state handler 104, may be implemented by a computing system. In such examples, correlator 102 and state handler 104 of the computing system may include any combination of hardware and programming to implement the functionalities of correlator 102 and state handler 104, as described herein in relation to any of FIGS. 1-6. For example, programming for correlator 102 and state handler 104 may be implemented as processor executable instructions stored on at least one non-transitory machine-readable storage medium and hardware may include at least one processing resource to execute the instructions. According to such examples, the at least one non-transitory machine-readable storage medium stores instructions that, when executed by the at least one processing resource, implement correlator 102 and state handler 104.

FIG. 5 is a block and schematic diagram generally illustrating a computing system 200 for implementing attribute bit-state mapper 100 according to one example. In the illustrated example, computing system or computing device 200 includes processing units 202, system memory 204, a graphics and memory controller hub 205 (sometimes referred to as a “northbridge”), a graphics system 206 including a graphics processing unit (GPU) 208 and GPU memory 210, an I/O control hub 212 (sometimes referred to as a “southbridge”), a network interface 214, non-removable storage 216, removable storage 218, and input/output devices 220.

In some examples, hardwired circuitry modules may be used as processing electronics in place of, or in combination with, processing units 202 and/or processor executable instructions stored in system memory 204 and/or non-removable storage 216 and removable storage 218. For example, the functionality of attribute bit-state mapper 100 may be implemented entirely or in part by logic contained in an application-specific integrated circuit (ASIC).

System memory 204 may be volatile (e.g. RAM), non-volatile (e.g. ROM, flash memory, etc.), or some combination thereof. Non-removable storage 216 and removable storage 218 may include, but are not limited to, magnetic or optical disks or tape. Computer storage media includes volatile and nonvolatile, removable and non-removable media implemented in any suitable method or technology for non-transitory storage of information such as computer readable instructions, data structures, program modules, or other data, and does not include transitory storage media. Computer storage media includes RAM, ROM, EEPROM, flash memory or other memory technology, CD-ROM, digital versatile disks (DVD) or other optical storage, magnetic cassettes, magnetic tape, and magnetic disc storage or other magnetic storage devices, for example.

Computing device 200 may also have additional features/functionality and additional or different hardware. For example, computing device 200 may include input/output devices 220 (e.g. keyboard, mouse, display, etc.), and network interface 214 that allows computing device 200 to communicate with other computers/applications, with the various elements of computing device 200 communicatively coupled together via various communication links.

System memory 204, non-removable storage 216, and removable storage 218 represent examples of computer storage media, including non-transitory computer readable storage media, storing computer executable instructions that when executed by one or more processors units of processing units 202 causes the one or more processors to perform the functionality of a system, such as attribute bit-state mapper 100. For example, as illustrated by FIG. 5, system memory 204 stores computer executable instructions 230 for attribute bit-state mapper 100, such as described above in relation to FIGS. 1-4, including correlator instructions 232 and state handler instructions 234, that when executed by one or more processing units of processing units 202 implement the functionalities of correlator 102 and state handler 104 of attribute bit-state mapper 100 as described herein, so as to maintain population data sets 236. In one example, state handler 234 includes computer executable instructions for the execution of comparison operations between current and past data sets of population data sets 236 by graphics system 206. According to one example, state handler 234 loads bit-states from population data sets 236 into GPU memory 210 on a slice-by-slice basis from current and past data sets (such as illustrated by slices “SL” from current and past data sets 132 and 134 of FIG. 3) for comparison operations by GPU 208. In one example, slices of current and past data sets have dimensions so that a single slice can be loaded into the buffer of GPU.

In one example, one or more of the at least one machine-readable medium storing instructions for at least one of correlator 102 and state handler 104 may be separate from but accessible to computing device 200. In other examples, hardware and programming may be divided among multiple computing devices.

In some examples, the computer executable instructions can be part of an installation package that, when installed, can be executed by the at least one processing unit to implement the functionality of at least one of correlator 102 and state handler 104. In such examples, the machine-readable storage medium may be a portable medium, such as a CD, DVD, or flash drive, for example, or a memory maintained by a server from which the installation package can be downloaded and installed. In other examples, the computer executable instructions may be part of an application, applications, or component already installed on computing device 200, including the processing resource. In such examples, the machine readable storage medium may include memory such as a hard drive, solid state drive, or the like. In other examples, the functionalities of at least one of correlator 102 and state handler 104 may be implemented in the form of electronic circuitry.

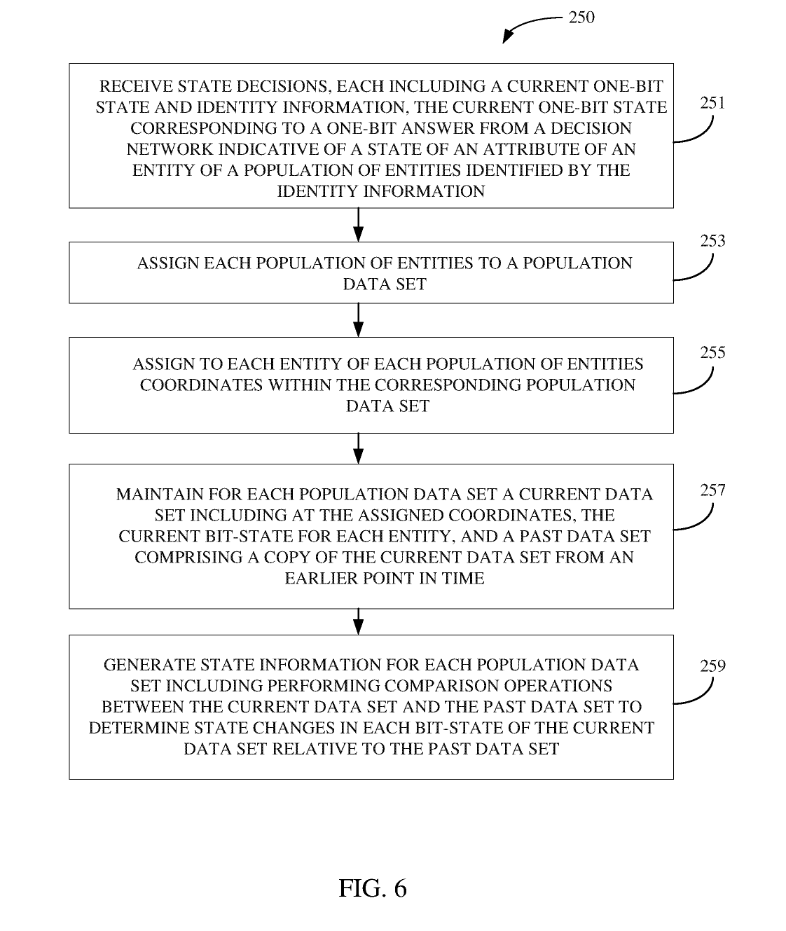

FIG. 6 is a flow diagram illustrating a method 250 of mapping attribute bit-states according to one example of the present disclosure. At 251, the method includes receiving state decisions, each state decision including a current one-bit state and identity information, the current one-bit state corresponding to a one-bit answer from a decision network indicative of a state of an attribute of an entity of a population of entities identified by the identity information, such as attribute bit-state mapper 100 of in relation to FIGS. 1 and 2 receiving state decisions 110 including bit-states 120 corresponding to one-bit answers from decision networks 112, and including identifying information 122 corresponding to entities 116 of populations of entities 114.

At 253, method 250 includes assigning each population of entities to a corresponding population data set, such as correlator 102 assigning populations of entities 114-1 to 114-N to corresponding population data sets 106-1 to 106-N as illustrated by FIGS. 1-2. At 255, method 250 further includes assigning to each entity of each population of entities coordinates within the corresponding population data set, such as correlator 102 assigning a population data set coordinate, a slice-coordinate “SL” within the population data set, and an x-y coordinate within the corresponding slice as illustrated by correlator 102 of FIG. 2 and data set 132 of FIG. 3.

At 257, method 250 includes maintaining for each population data set a current data set including, at the assigned coordinates, the current bit-state for each entity and a past data set comprising a copy of the current data set from an earlier point in time, such as state handler 104 maintaining current and past data sets 132 and 134 as illustrated by FIGS. 1-3. At 259, method 250 includes generating state information for each population data set, including performing comparison operations between the current data set and the past data set to determine state changes in each of the bit-states of the current data set relative to the past data set, such as data handler 104 performing comparisons between current and past data sets 132 and 134 as illustrated by FIG. 1. In one example, comparison operations between the current data set and past data set include performing one or more bit-wise comparison operations. In one example, such bit-wise comparison operations include bitwise operations such as AND, OR, NOR, and XOR, for example. In one example, comparison operation include determining total numbers of bit-states in a population data set having first states (e.g. a state of “1”) and second states (e.g. a state of “0”). According to one example, method 250 includes performing such comparison operations using a GPU, such as GPU 208 of GPU system 206 of FIG. 5.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
an attribute bit state mapper including:
a correlator to:
receive state decisions, each state decision including a current one-bit state and identity information, the current one-bit state corresponding to a one-bit answer from a decision network indicative of a state of an attribute of an entity of a population of entities identified by the identity information;
assign each population of entities to a population data set; and
assign to each entity of a population data set coordinates within the corresponding population data set;
a memory; and
a state handler to maintain, in the memory, for each population data set a current data set including, at the assigned coordinates, the current bit-state for each entity, and a past data set comprising a copy of the current data set from an earlier point in time.

2. The system of claim 1, the coordinates assigned to each entity of a population of entities being persistent over a life of the population data set.

3. The system of claim 1, the state handler to generate state information for each population data set, including to perform a set of comparison operations between the current data set to the past data set to determine state changes in each of the bit-states of the current data set relative to the past data set.

4. The system of claim 3, the state handler to generate state information including a state count of a number of bit-states of the current data set having each state.

5. The system of claim 3, the state handler to generate state information for each population data set at selected intervals.

6. The system of claim 3, the set of comparison operations including bitwise operations.

7. The system of claim 3, the state handler including a graphics processing unit of a graphics processing system to perform the comparison operations.

8. The system of claim 3, the state handler to maintain a difference data set comprising results of a comparison operation between the current data set and past data set.

9. The system of claim 3, after determining state information for a population data set, the state handler to replace the past data set with a copy of the current data set.

10. A method of operating a bit-state mapper comprising:
receiving state decisions, each state decision including a current one-bit state and identity information, the current one-bit state corresponding to a one-bit answer from a decision network indicative of a state of an attribute of an entity of a population of entities identified by the identity information;
assigning each population of entities to a population data set;
assigning to each entity of a population of entities persistent coordinates within the corresponding population data set;
maintaining for each population data set a current data set including, at the assigned coordinates, the current one-bit state for each entity, and a past data set comprising a copy of the current data set at an earlier point in time; and
generating state information for each population data set, including performing comparison operations between the current data set and the past data set to determine state changes in each of the bit-states of the current data set relative to the past data set.

11. The method of claim 10, generating state information for each population data set including providing a state count of a number of bit-states of the current data set having each state

12. The method of claim 11, generating state information including performing the comparison operations and state count with a graphics processing unit.

13. The method of claim 10, including saving a copy of the current data set as the past data set for a population data set upon completion of generating state information for the population data set.

14. A non-transitory computer-readable storage medium comprising computer-executable instructions executable by at least one processor to implement an attribute bit state mapper to:
receive state decisions, each state decision including a current one-bit state and identity information, the current one-bit state corresponding to a one-bit answer from a decision network indicative of a state of an attribute of an entity of a population of entities identified by the identity information;
assign each population of entities to a population data set;
assign to each entity of a population of entities coordinates within the corresponding population data set; and
maintain for each population data set a current data set including, at the assigned coordinates, the current one-bit state for each entity, and a past data set comprising a copy of the current data set at an earlier point in time.

15. The non-transitory computer-readable storage medium of claim 14, further including instructions executable by the at least one processor to implement the attribute bit state mapper to:
generate state information for each population data set, including to perform comparison operations between the current data set and the past data set to determine state changes in each of the bit-states of the current data set relative to the past data set.
